(19) United States
(12) Patent Application Publication
(10) Pub. No.: US 2008/0315056 A1
(43) Pub. Date: Dec. 25, 2008

(54) Connecting Device for Pendent Lamp

(76) Inventor: Keen Hsu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/766,005

(22) Filed: Jun. 20, 2007

(51) Int. Cl. F21V 21/10; F21V 21/03; F21V 21/13

(52) U.S. Cl. 248/324

(57) ABSTRACT

A connecting device for a pendent lamp includes a first connector and a second connector rotatably mounted on the first connector. Thus, the first connector is rotatable relative to the second connector to adjust the angle and direction of the pendent lamp so that the pendent lamp is adjustable to have the optimum angle and direction. In addition, the rotation ring of the second connector is limited between the first threaded connecting member and the second threaded connecting member of the first connector after the first threaded connecting member and the second threaded connecting member of the first connector are combined together so that the connecting device is assembled easily and quickly.

### BACKGROUND OF THE INVENTION

1. Field of the Invention

The present invention relates to a connecting device and, more particularly, to a connecting device for a lamp, such as a pendent lamp and the like.

2. Description of the Related Art

A conventional connecting device for a pendent lamp is used to attach a pendent lamp to a ceiling in the house. However, the pendent lamp has a larger volume so that the pendent lamp cannot be mounted onto the ceiling easily and conveniently, thereby greatly causing in convenience to the user in assembly of the pendent lamp. In addition, the angle and direction of the pendent lamp is fixed and cannot be adjusted easily after the pendent lamp is mounted onto the ceiling.

### BRIEF SUMMARY OF THE INVENTION

In accordance with the present invention, there is provided a connecting device for a pendent lamp, comprising a first connector and a second connector rotatably mounted on the first connector.

The primary objective of the present invention is to provide a connecting device for a pendent lamp, wherein the first connector is rotatable relative to the second connector to adjust the angle and direction of the pendent lamp so that the pendent lamp is adjustable to have the optimum angle and direction.

Another objective of the present invention is to provide a connecting device for a pendent lamp, wherein the first limit boss of the first connector is movable to abut the second limit boss of the second connector to prevent the first connector from being rotatable relative to the second connector to an excessive extent, thereby preventing the electric wires of the pendent lamp from being distorted or tangled.

A further objective of the present invention is to provide a connecting device for a pendent lamp, wherein the pendent lamp is rotatable freely to adjust the angle and direction by its own weight so that the pendent lamp is disposed at a depending state.

A further objective of the present invention is to provide a connecting device for a pendent lamp, wherein the rotation ring of the second connector is limited between the first threaded connecting member and the second threaded connecting member of the first connector after the first threaded connecting member and the second threaded connecting member of the first connector are combined together so that the connecting device is assembled easily and quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a connecting device for a pendent lamp in accordance with the preferred embodiment of the present invention.

FIG. 2 is a front cross-sectional view of the connecting device in accordance with the preferred embodiment of the present invention.

FIG. 3 is an exploded perspective view of the connecting device as shown in FIG. 2.

FIG. 4 is a front cross-sectional view of a first connector of the connecting device as shown in FIG. 2.

FIG. 5 is an exploded perspective view of the first connector of the connecting device as shown in FIG. 4.

FIG. 6 is a perspective view of a second connector of the connecting device as shown in FIG. 2.

FIG. 7 is a perspective view of a rotation ring of the second connector as shown in FIG. 6.

### DETAILED DESCRIPTION OF THE INVENTION

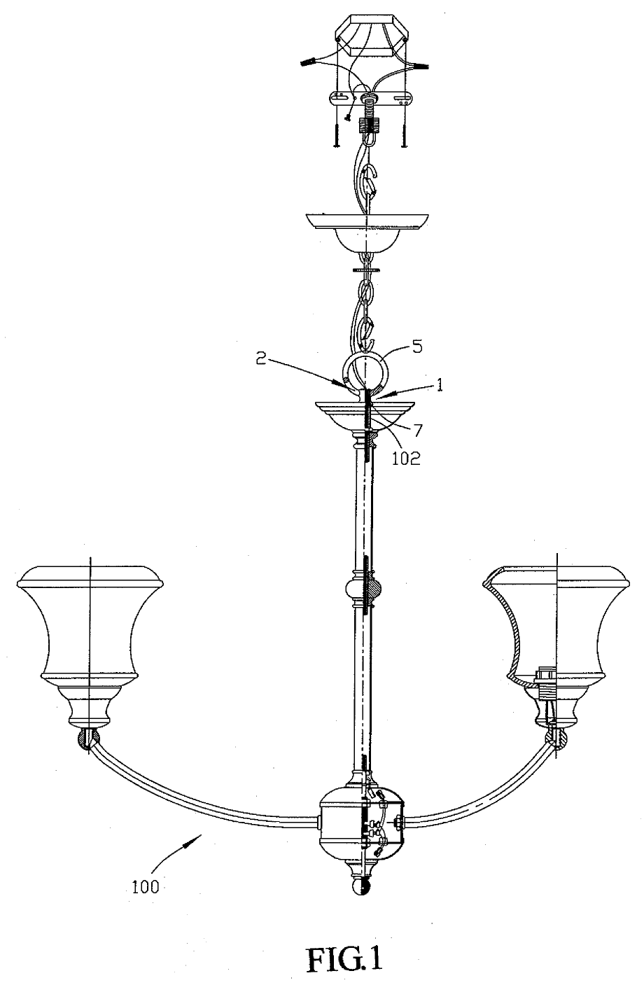

Referring to the drawings and initially to FIG. 1, a connecting device for a pendent lamp 100 in accordance with the preferred embodiment of the present invention comprises a first connector 1 and a second connector 2 rotatably mounted on the first connector 1.

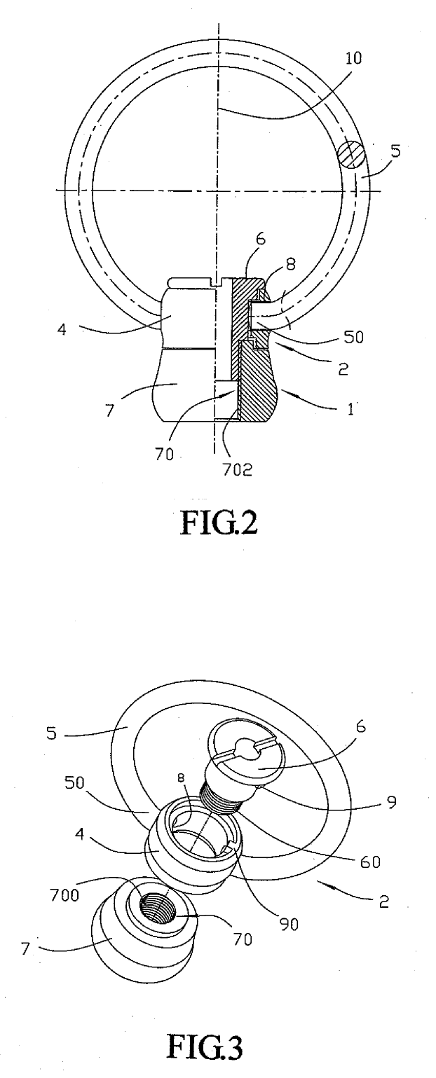

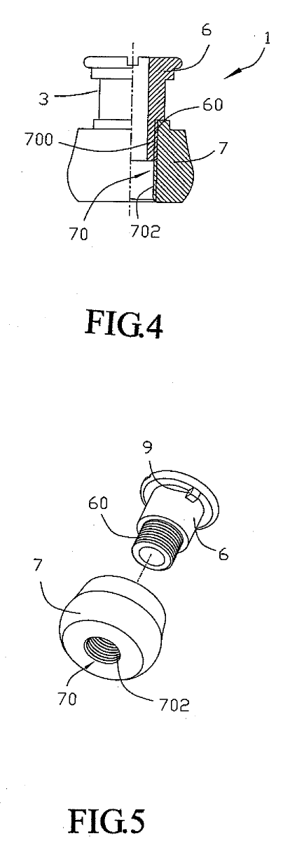

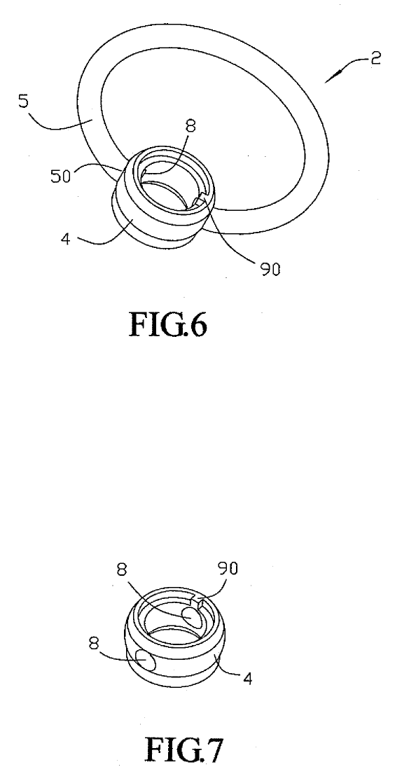

Referring to FIGS. 1-7, the first connector 1 has an axis 10 directed in an upright direction. The first connector 1 includes a first threaded connecting member 6 and a second threaded connecting member 7 connected with the first threaded connecting member 6. The first connector 1 has an annular groove 3 formed between a peripheral wall of the first threaded connecting member 6 and a peripheral wall of the second threaded connecting member 7. The annular groove 3 of the first connector 1 has a periphery formed with a first limit boss 9. Preferably, the first limit boss 9 is formed on the first threaded connecting member 6 of the first connector 1 and protrudes radially and outwardly from the first threaded connecting member 6 of the first connector 1. The first threaded connecting member 6 of the first connector 1 is formed with an outer thread 60. The second threaded connecting member 7 of the first connector 1 is formed with an inner thread 70 screwed onto the outer thread 60 of the first threaded connecting member 6 to combine the second threaded connecting member 7 and the first threaded connecting member 6 together. Preferably, the inner thread 70 of the second threaded connecting member 7 has a first portion formed with a first inner threading 700 screwed onto the outer thread 60 of the first threaded connecting member 6 to combine the first threaded connecting member 6 and the second threaded connecting member 7 of the first connector 1 together and a second portion formed with a second inner threading 702 screwed onto a threaded rod 102 of the pendent lamp 100 to combine the second threaded connecting member 7 of the first connector 1 with the threaded rod 102 of the pendent lamp 100 together so as to attach the pendent lamp 100 to the connecting device.

The second connector 2 includes a rotation ring 4 rotatably mounted in the annular groove 3 of the first connector 1 and a pull member 5 snapped onto the rotation ring 4. The rotation ring 4 of the second connector 2 is limited between the first threaded connecting member 6 and the second threaded connecting member 7 of the first connector 1 and has an inner wall formed with a second limit boss 90 that is movable to abut the first limit boss 9 of the first connector 1. The second limit boss 90 protrudes radially and inwardly from the rotation ring 4 of the second connector 2. The rotation ring 4 of the second connector 2 has a peripheral wall formed with two radially opposite locking holes 8. The pull member 5 of the second connector 2 is substantially C-shaped and has two opposite ends 50 each snapped into and rotatably mounted in a respective locking hole 8 of the rotation ring 4 to attach the pull member 5 to the rotation ring 4.

In assembly, the pull member 5 of the second connector 2 is secured on a ceiling (not shown), and the second inner threading 702 of the second threaded connecting member 7 is screwed onto the threaded rod 102 of the pendent lamp 100 to combine the second threaded connecting member 7 of the first connector 1 with the threaded rod 102 of the pendent lamp 100 together so as to attach the pendent lamp 100 to the ceiling by the connecting device. At this time, the rotation ring 4 of the second connector 2 is rotatable between the first threaded connecting member 6 and the second threaded connecting member 7 of the first connector 1 so that the first connector 1 is rotatable relative to the second connector 2 to adjust the angle of the pendent lamp 100. In addition, the first limit boss 9 of the first connector 1 is movable to abut the second limit boss 90 of the second connector 2 to prevent the first connector 1 from being rotatable relative to the second connector 2 to an excessive extent, thereby preventing the electric wires of the pendent lamp 100 from being distorted or tangled.

Accordingly, the first connector 1 is rotatable relative to the second connector 2 to adjust the angle and direction of the pendent lamp 100 so that the pendent lamp 100 is adjustable to have the optimum angle and direction. In addition, the first limit boss 9 of the first connector 1 is movable to abut the second limit boss 90 of the second connector 2 to prevent the first connector 1 from being rotatable relative to the second connector 2 to an excessive extent, thereby preventing the electric wires of the pendent lamp 100 from being distorted or tangled. Further, the pendent lamp 100 is rotatable freely to adjust the angle and direction by its own weight so that the pendent lamp 100 is disposed at a depending state. Further, the rotation ring 4 of the second connector 2 is limited between the first threaded connecting member 6 and the second threaded connecting member 7 of the first connector 1 after the first threaded connecting member 6 and the second threaded connecting member 7 of the first connector 1 are combined together so that the connecting device is assembled easily and quickly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A connecting device for a pendent lamp, comprising:
a first connector;
a second connector rotatably mounted on the first connector.

2. The connecting device for a pendent lamp in accordance with claim 1, wherein:
the first connector has an annular groove;
the second connector includes a rotation ring rotatably mounted in the annular groove of the first connector and a pull member snapped onto the rotation ring.

3. The connecting device for a pendent lamp in accordance with claim 2, wherein:
the first connector includes a first threaded connecting member and a second threaded connecting member connected with the first threaded connecting member;
the annular groove of the first connector is formed between a peripheral wall of the first threaded connecting member and a peripheral wall of the second threaded connecting member.

4. The connecting device for a pendent lamp in accordance with claim 3, wherein:
the first threaded connecting member of the first connector is formed with an outer thread;
the second threaded connecting member of the first connector is formed with an inner thread screwed onto the outer thread of the first threaded connecting member to combine the second threaded connecting member and the first threaded connecting member together.

5. The connecting device for a pendent lamp in accordance with claim 4, wherein the inner thread of the second threaded connecting member has a first portion formed with a first inner threading screwed onto the outer thread of the first threaded connecting member to combine the first threaded connecting member and the second threaded connecting member of the first connector together.

6. The connecting device for a pendent lamp in accordance with claim 5, wherein the inner thread of the second threaded connecting member has a second portion formed with a second inner threading.

7. The connecting device for a pendent lamp in accordance with claim 3, wherein the rotation ring of the second connector is limited between the first threaded connecting member and the second threaded connecting member of the first connector.

8. The connecting device for a pendent lamp in accordance with claim 3, wherein:
the annular groove of the first connector has a periphery formed with a first limit boss;
the rotation ring of the second connector has an inner wall formed with a second limit boss that is movable to abut the first limit boss of the first connector.

9. The connecting device for a pendent lamp in accordance with claim 8, wherein the first limit boss is formed on the first threaded connecting member of the first connector.

10. The connecting device for a pendent lamp in accordance with claim 8, wherein the first limit boss protrudes radially and outwardly from the first threaded connecting member of the first connector.

11. The connecting device for a pendent lamp in accordance with claim 8, wherein the second limit boss protrudes radially and inwardly from the rotation ring of the second connector.

12. The connecting device for a pendent lamp in accordance with claim 2, wherein:
the rotation ring of the second connector has a peripheral wall formed with two radially opposite locking holes;
the pull member of the second connector has two opposite ends each snapped into and rotatably mounted in a respective locking hole of the rotation ring to attach the pull member to the rotation ring.

13. The connecting device for a pendent lamp in accordance with claim 12, wherein the pull member of the second connector is substantially C-shaped.

14. The connecting device for a pendent lamp in accordance with claim 1, wherein the first connector has an axis directed in an upright direction.

15. The connecting device for a pendent lamp in accordance with claim 3, wherein the rotation ring of the second connector is rotatable between the first threaded connecting member and the second threaded connecting member of the first connector so that the first connector is rotatable relative to the second connector.

16. The connecting device for a pendent lamp in accordance with claim 8, wherein the first limit boss of the first connector is movable to abut the second limit boss of the second connector to prevent the first connector from being rotatable relative to the second connector to an excessive extent.

17. The connecting device for a pendent lamp in accordance with claim 1, wherein the first connector is rotatable relative to the second connector.
